(19) United States
(12) Patent Application Publication
(10) Pub. No.: US 2002/0077148 A1
(43) Pub. Date: Jun. 20, 2002

(54) METHOD OF PERFORMING TELECOMMUNICATION FUNCTIONS AS WELL AS A LINE-SIDE DEVICE, NODAL POINT, DATA PROCESSING INSTALLATION, TERMINAL AND TELECOMMUNICATION SYSTEM THEREFOR

(76) Inventor: WIESLAWA WAJDA, KELTERN (DE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/173,825

(22) Filed: Oct. 16, 1998

(30) Foreign Application Priority Data
Oct. 18, 1997 (DE) 197 46 132.8

(51) Int. Cl. H04Q 7/20

(52) U.S. Cl. 455/560; 455/422

(57) ABSTRACT

A method is shown for performing telecommunication functions, whereby at least a first line-side device (NE1) in a telecommunications network (TCN) and at least one terminal (TER) for the telecommunications network (TCN) can be connected to each other, and form the functions through the interaction of first function parts (F1) performed by the terminal, and second function parts (F21) performed by the first line-side device, as long as the terminal is connected to the first line-side device. It is proposed that if the terminal is not connected to the first line-side device, and the first function parts (F1) are therefore unable to interact with the second function parts (F21), the line-side device (NE1) replaces or simulates the first function parts (F1) with third function parts (F31), and that as a function of at least one determinable parameter, a second line-side device (NE2) instead of the first line-side device performs such function parts (F22, F32), which are at least comparable to the second function parts (F21) of the first line-side device. A line-side device (NE1) is also shown, as well as a nodal point, a data processing installation, a terminal (TER) and a telecommunication system for performing telecommunication functions.

### BACKGROUND OF THE INVENTION

1. Technical Field

The present invention concerns a method of performing telecommunication functions, a nodal point therefor, a data processing installation therefor, a terminal therefor, and a telecommunication system therefor.

2. Discussion of Related Art

Mobile radio networks in particular fulfill the needs of increasing mobility for telecommunication subscribers. A subscriber uses his terminal to log on to different places in a mobile radio network and to utilize the services of the mobile radio network. On the other hand the subscriber can also be reached by calls from the mobile radio network or from other telecommunications networks. As long as the subscriber has not logged his terminal on to the mobile radio network, a device in the mobile radio network can take over the function of answering a call, accepting incoming calls and storing messages left by the respective callers.

When the subscriber logs on to the mobile radio network, the MSC (Mobile services Switching Center) in the effective range of which the subscriber is located, next obtains the data identifying the subscriber from a data bank. Depending on where the subscriber is located, the data bank being used is his home data bank, the socalled HLR (Home Location Register), or a visitor's data bank, the so-called VLR (Visitor Location Register). The identifying data are, e.g., rate information, or a subscriber-specific service profile, i.e., a list of service functions that are made available to the subscriber. The already mentioned call answering function could be such a service, e.g.

In addition to the availability of a standardized environment of service functions independently of location, it is essential that a mobile subscriber can always be reached with a telephone number that remains constant. In the mobile radio area such a universal telecommunications network is found under the UMTS concept (Universal Mobile Telecommunication System), which is composed of different mobile radio networks. The subscriber mobility is expanded even further with ‘Universal Personal Telecommunications’ (UPT) since a constant telephone number reaches him not only in mobile radio networks, but also in so-called intelligent networks. The subscriber can log on to a UPT network with a terminal for mobile radio systems, as well as with a terminal for line-conducted telecommunications networks. Usually however, UPT networks also assign different telephone numbers to different types of instruments, e.g., telephone sets and fax machines so that, depending on the kind of desired communication, a UPT subscriber needs different identifiers.

The known forms of mobile telecommunication by a subscriber refer essentially to mobile radio networks and UPT networks, where the telecommunication functions are used with a mobile radio telephone set or with a line-conducted telephone set. In that case the mobile subscriber's possibilities of communication are oriented to the technical service features of the terminal being used. If while he is traveling, the mobile subscriber, e.g., wants to receive a fax with a mobile radio telephone set that can only process voice data, he cannot receive this fax, or he can only receive it on a fax machine in his place of work which can be reached through an identifier assigned to said fax machine.

### SUMMARY OF INVENTION

The object of this invention is to perform telecommunication functions for a subscriber in different locations within a telecommunications network, independently of whether or not a suitable subscriber terminal that can be connected to the telecommunications network, is connected to the telecommunications network.

According to a first aspect of the invention, a method of performing telecommunication functions, whereby at least a first line-side device in a telecommunications network, and at least a first terminal for the telecommunications network can be connected to each other, wherein the first line-side device checks whether it is connected to the first terminal, and wherein the functions are formed by the interaction of first function parts which are performed by the first terminal, and second function parts which are performed by the first line-side device, as long as the first terminal is connected to the first line-side device, is characterized in that if the first terminal is not connected to the first line-side device and the first function parts are therefore unable to interact with the second function parts, the first line-side device replaces or simulates the first function parts with third function parts, and that as a function of at least one determinable parameter, a second line-side device instead of the first line-side device performs such function parts, which are at least comparable to the second function parts of the first line-side device.

According to a second aspect of the invention, a line-side device in a telecommunications network for performing telecommunication functions, which contains means for connecting the telecommunications network to at least one first terminal, which contains means whereby it is able to check whether it is connected to the first terminal, and which has means for performing second function parts which form the telecommunication functions by interacting with first function parts performed by the first terminal, as long as the first terminal is connected to the line-side device, is characterized in that the line-side device has means for replacing or simulating the first function parts through third function parts, if the first terminal is not connected to the line-side device, and the first function parts are therefore unable to interact with the second function parts, and that the line-side device has means for evaluating a command which instructs the line-side device to perform the second or third function parts.

According to a third aspect of the invention, a nodal point for a telecommunications network is characterized in that it contains at least one line-side device according to the second aspect of the invention.

According to a fourth aspect of the invention, a data processing installation for a telecommunications network is characterized in that it contains at least one line-side device according to the second aspect of the invention.

According to a fifth aspect of the invention, a terminal for a telecommunications network containing at least one line-side device according to the second aspect of the invention, where the terminal has a device for a connection to the line-side device and means for performing first function parts, which are able to interact with the second function parts of the line-side device, is characterized in that the terminal has means whereby, when the terminal is connected to the line-side device, it is able to transmit at least one service feature of the first function parts of line-side device.

According to a sixth aspect of the invention, a telecommunication system comprising a telecommunications network which contains nodal points and transmission paths, and to which at least one terminal can be connected, and which contains a first network that has at least one device for performing service functions, is characterized in that the telecommunication system contains a second network with line-side devices (N1) for performing telecommunication functions, which is connected to the telecommunications network and to the first network as well.

These and other objects, features and advantages of the present invention will become more apparent in light of the detailed description of a best mode embodiment thereof, as illustrated in the accompanying drawing.

### BRIEF DESCRIPTION OF THE DRAWING

The invention and its advantages are represented in the following by means of an embodiment with the help of the drawings, where:

FIG. 1 illustrates an example of an arrangement whereby the method of the invention can be applied, which contains two line-side devices according to the invention, plus a telecommunications network and a terminal according to the invention.

FIG. 2 illustrates a telecommunication system according to the invention, in which a terminal according to the invention, a telecommunications network, a first network with devices for performing service functions, and a second network of line-side devices are all interconnected.

### DETAILED DESCRIPTION OF PREFERRED EMBODIMENTS

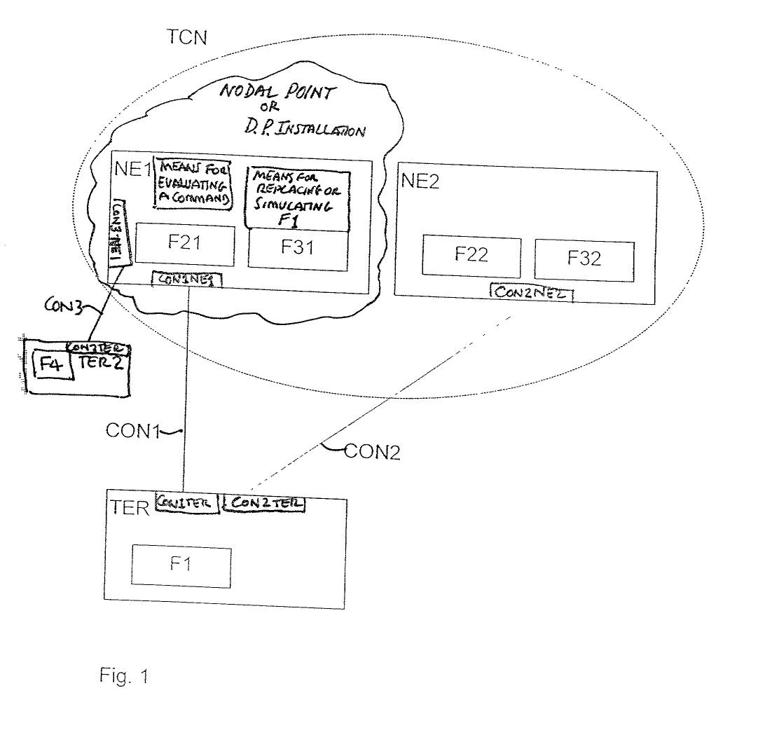

FIG. 1 illustrates an arrangement whereby the method of the invention can be applied. A telecommunications network TCN for example contains two line-side devices NE1 and NE2, which represent a number of possible other line-side devices within the telecommunications network TCN. The telecommunications network TCN contains connections that are not illustrated in FIG. 1, e.g., the line-side devices NE1 and NE2 may be connected to each other. The telecommunications network TCN can be a homogeneous telecommunications network, or it can be formed of a number of partial networks, e.g., of a combination of diverse mobile radio networks and line-conducted telephone networks.

FIG. 1 furthermore depicts a terminal TER with a function block F1, which represents means for performing first function parts. For example the terminal TER can be a telephone set, a fax machine or a personal computer. The microprocessors, storage devices, input devices and output devices contained in such terminals are able, e.g., to perform the first function parts. The terminal TER can be connected both to the line-side device NE1 via a connection CON1 terminated in the line-side device NE1 by termination means CON1NE1 and in the terminal TER by termination means CON1TER, and to the line-side device NE2 via a connection CON2 terminated in the line-side device NE2 by termination means CON2NE2 and in the terminal TER by termination means CON2TER. The means CON1TER and the means CON2NE2 can check whether they are connected to the first terminal TER or to a second terminal TER2 which is connected to the line-side device NE1 by a connection CON3 that is terminated in the lineside device NE1 by termination means CON3TER2 and by terminal TER2 by termination means CON3TER. The terminal TER2 includes a function block F4 for performing fourth function parts.

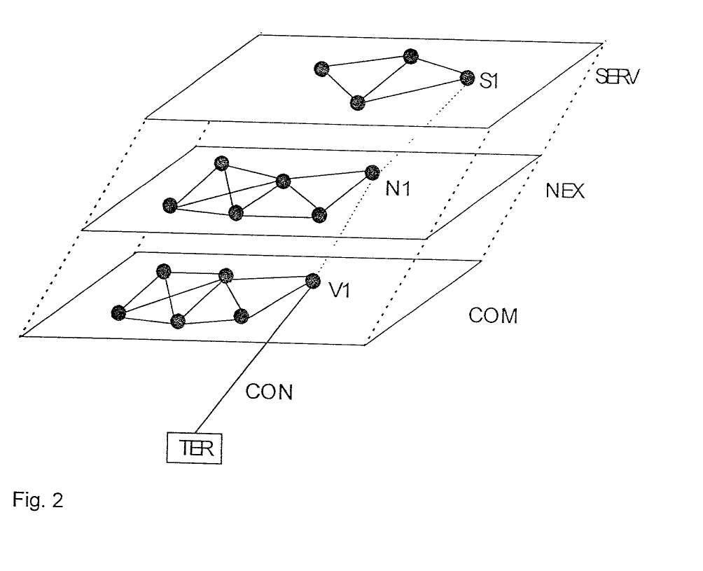

Line-side device NE1 contains two function blocks F21 and F31, and line-side device NE2 contains two function blocks F22 and F32. The function block F21 symbolizes means for performing second function parts, the function block F31 means for performing third function parts. The function block F22 in the line-side device NE2 can perform second or comparable function parts. The function block F32 can perform the third or comparable function parts. The means for performing the function parts in the line-side devices NE1 and NE2 can, e.g., be systems containing a microprocessor, a storage device for program codes, input devices and output devices, but also more complex systems whose architecture and interaction will be explained in greater detail by means of FIG. 2. Since the function blocks F22 and F32 of the line-side device NE2 can contain differently structured means than the function blocks F21 and F31 of the line-side device NE1, e.g., different microprocessors, the configuration of the second and third function parts in the two line-side devices NE1 and NE2 can be different. To simplify the illustration, the following only mentions the respective second and third function portions in connection with function blocks F22 and F32, without providing further details of an equivalent fulfillment of the function parts.

The extent and the arrangement of the telecommunication functions to be performed by the line-side devices NE1 and NE2 can be determined in general for all subscribers, for a group of subscribers, or individually for one subscriber, and with the subscriber-specific service profile mentioned in the beginning. Such a service profile can be stored in a memory in the telecommunications network TCN, or in one or several of the line-side devices. The service profile can, e.g., describe the possible configurations of the terminal TER whereby a subscriber can be reached, e.g., personal computer or mobile radio telephone, and which service features are offered by the terminal TER, e.g., what types of data the terminal TER is able to evaluate. It is also possible to reach the subscriber via several terminals. In that case the service profile lists the characteristics of these terminals.

To utilize the telecommunication functions of the telecommunications network TCN, the subscriber logs his terminal TER on to the telecommunications network TCN. To that end a connection is established between the terminal TER and the telecommunications network TCN. This connection may be line-connected or may take place via a radio path. The terminal TER now sends an identification code to the telecommunications network TCN for the connection request to the line-side device NE1, whereby the telecommunications network TCN establishes the connection CON1. The connection CON1 enables the terminal TER to transmit data about its service features to the line-side device NE1. In this way the line-side device NE1 can be informed, e.g., that the terminal TER is a fax machine or a telephone set which includes a display device. However, it is also possible to omit the transmission of the service feature data, e.g., because the subscriber only uses a single type of device as his terminal TER, whose service features are already known to the line-side device NE1 through the already described service profile, or because the terminal TER is a universal device with characteristics for which the line-side device NE1 does not require any tuning. Further steps are possible within the framework of the registration procedure, such as, e.g., an authentication process to prevent unauthorized usage of telecommunication functions which are charged to the subscriber and are not explained in detail in this instance.

After the logon procedure, the function block F1 in the terminal TER and the function block F21 in the line-side device NE1 can interact. For example function block F1 can transmit a connection request to function block F21, and the request is entered by means of a keyboard on terminal TER. The function block F21 then determines a favorable rate for a connection path in the telecommunications network TCN, e.g., with the help of a rate chart. The desired connection is then established via this connection path.

The function blocks F21 and F1 can also interact favorably with calls received by the line-side device NE1. In the simplest case the terminal TER is a telephone set and the incoming call is a voice communication. In that case the function block F21 only routes voice data from the telecommunications network TCN to the function block F1, and vice versa. However if the line-side device NE1 receives an e-mail, the function block F21 can, e.g., convert the e-mail into voice data, which the function block F1 can then convert into acoustic signals. In this way it is possible to convert other incoming data, which are not compatible with the respective function block F1 of terminal TER, into compatible formats. However function block F21 can also route these incoming data to function block F31 for intermediate storage, so that the data can be recalled by a different type of terminal TER, by a personal computer, e.g., in the case of e-mail.

A log-off procedure, e.g., by sending a log-off message, allows the terminal TER to sever the connection CON1 to the line-side device NE1. The line-side device NE1 then replaces the first function parts which would otherwise have been performed by function block F1, with third function parts performed by function block F31. The function block F31, e.g., can divert an incoming call to another destination, or accept it by acting as an answering set. The function block F31 is also able to identify the caller, e.g., by means of voice recognition or the so-called ‘Calling Line Identification Presentation’ in ISDN telecommunications networks, and send him a message that was especially left for him. Also in the event of an unintended disengagement of the connection CON1, e.g., the interruption of a radio connection between terminal TER and the telecommunications network TCN, the function block F31 takes the place of function block F1 as well. The lack of the connection CON1 is recognized by the line-side device NE1 by means of a connection check, e.g., by sending a test pattern message to the terminal TER by means CON1NE1, which TER must answer.

The invention supports subscriber mobility in a particularly advantageous manner. On the one hand it is possible to connect terminal TER to the telecommunications network TCN at several connection points, and from there to establish a respective connection CON1 to the line-side device NE1; on the other hand the line-side device NE2 can also be connected to the terminal TER via CON2, and is able to fully or partially perform the functions of the line-side device NE1. In that case function block F22 takes the place of function block F21, and function block F32 takes the place of function block F31. As mentioned in the example at the beginning, the line-side device NE2 can be located in a nodal point which is nearer to the terminal TER. However the line-side devices NE1 and NE2 may also be part of two different data processing installations with different capacity utilizations. If the capacity utilization of the data processing installation of lineside device NE1 is greater than that of line-side device NE2, line-side device NE2 takes over the function parts of line-side device NE1. The utilization of the transmission capacity of the telecommunications network TCN, or the establishment of rates for the use of line-side devices NE1 and NE2, can also lead to a transfer of functions between them. The transfer of functions can be triggered, e.g., by a central control element in the telecommunications network TCN, or by the terminal TER or even by the line-side devices NE1 and NE2 themselves.

As already described, by means of a rate chart the function block F21 is able to establish a connection to a communications partner, which can be reached via a known terminal, e.g., a telephone set. But it is especially advantageous if the function block F21 establishes a connection to a communications partner for whom a third line-side of the invention is working. For example if the line-side device NE1 wants to send data to the third line-side device, the line-side device NE1 can first inquire with the third line-side device in what format the data should be sent.

The terminal TER can issue a command to the line-side device NE1, so that in the case of low capacity utilization by the telecommunications network TCN, it performs a data transfer to the communications partner device, or sends a message, e.g., a wake-up call at a predeterminable time. The line-side device NE1 carries out the command by itself, independently of whether the terminal TER is connected to it at the time.

If only one terminal TER is jointly available to a first and a second subscriber of the telecommunications network TCN, the terminal TER can be simultaneously connected to two line-side devices. In the present example line-side device NE1 works, e.g., for the first subscriber, and line-side device NE2 for the second subscriber, and the terminal TER is connected to line-side devices NE1 or NE2 via connections CON1 and CON2. In that case function block F21 can process, e.g., an incoming telephone call for the first subscriber in the above described manner together with function block F1. If a call for the second subscriber arrives in the function block F22 during this telephone call, the function block F22 is able to send a message about this event to function block F1, which the latter reads out, e.g., on a display device in the terminal TER.

If the terminal TER is simultaneously connected to both line-side devices NE1 or NE2, these are also able to perform function parts in that function blocks F21 and F22 and functions blocks F31 and F32 respectively perform a portion of the second and third function parts. A function block F1 in a terminal TER, which is able to process fax data as well as a telephone call, is then supplied, e.g., with fax data by the function block F21, and processes the telephone call data together with function block F22.

If two different types of terminals are simultaneously connected to the line-side device NE1, e.g., a telephone set TER and a fax machine TER2, the function block F21 is able to route incoming data to the respective terminal TER whose function block F1 or F4 can best process the data. In that case function block F21 preferably sends voice data to the telephone set TER, video data and text data to the fax machine TER2, where the data are issued by the respective function block F1 or F4. However the line-side device NE1 is also able to predetermine which data types are assigned to what type of terminal. Thus function block F21 is able to route e-mail to the fax machine for printing, or to the telephone set for read-out on a display device. This predetermination becomes easier if a single terminal TER contains input and output means for many kinds of acoustical and optical media, such as, e.g., a multimedia-PC.

In addition to the telecommunication functions, the line-side device NE1 is also able to offer application program functions by interacting with the terminal TER. Application programs are, e.g., text processing, table calculations, video processing or a combination of such data processing programs. Thus with the help of the line-side device NE1, a subscriber is not only able to send and receive data, but also to process them, e.g., convert, modify, copy and store them. But application programs can also be a subscriber's personal calendar or his personal telephone directory, whose inputs are managed by the line-side device NE1. The latter is able to store the inputs by itself, or let them be stored by another device, e.g., a data bank in the telecommunications network TCN.

The fact that the telecommunications network TCN, with the help of one or more line-side devices in different places, offers the subscriber the possibility of utilizing telecommunication functions and application program functions which he can personally define, means that the telecommunications network TCN makes a virtual telecommunications and working environment available to the subscriber. The subscriber can be reached at any time in this environment because, e.g., if no subscriber terminal TER is connected to the telecommunications network TCN, the functions of the terminal TER are replaced or simulated. Even when the subscriber is unable or does not wish to operate the terminal TER, e.g., when he is not accepting a telephone call, the telecommunications and working environment performs its own function parts instead of the function parts that were not performed by the terminal TER, e.g., it activates the already mentioned answering function. Assigning a virtual telecommunications and working environment to a subscriber provides the possibility of calculating the charges for the use of telecommunication functions, independently of the usage site.

FIG. 2 illustrates a telecommunication system according to the invention. The system is divided into three network planes shown in parallelogram form, which contain the networks NEX and SERV that are symbolized by interconnected nodal points; they also contain a symbolized telecommunications network COM. Dotted lines between the corner points of the network planes represent examples of not further illustrated connections between the telecommunications network COM, the network NEX and the network SERV. The lowermost network plane forms the telecommunications network COM which essentially performs transmission and exchange functions. For that reason and to simplify matters, only exchanges of the telecommunications network COM are shown as nodal points and transmission paths between the nodal points. A terminal TER is connected to the telecommunications network COM, as already described in relation to FIG. 1. The second network NEX with line-side devices according to the invention is located above the telecommunications network COM, and the devices are located in the nodal points of the network NEX and are thereby interconnected. The uppermost plane forms the first network SERV whose nodal points contain devices that perform service functions. Such devices can, e.g., be data processing installations which detect data bank functions or perform service programs and application programs, and can be performed, e.g., by the terminal TER or by a line-side device of the network NEX.

As described, the telecommunications network COM and the networks NEX and SERV can also be located in delimited real network planes, whose nodal points and connection lines are clearly assigned to one of the respective networks, as well as in logic network planes which are defined by their functions. In this way a nodal point of telecommunications network COM, e.g., can contain one or several line-side devices according to the invention, or it can even have a data processing installation which is logically assigned to the network SERV. A data processing installation of the network SERV can also contain several line-side devices according to the invention. Other combinations of devices of the telecommunications network COM and the networks NEX and SERV are possible, but do not impair the functional separation into the mentioned three logic network planes. In addition to the symbolically depicted nodal points and connection lines, the telecommunications network COM and the networks NEX and SERV also contain other not illustrated typical network installations, e.g., concentrators, out-of-area equipment and network control devices.

To utilize the telecommunication system illustrated in FIG. 2, a connection line CON first connects the terminal TER to a nodal point V1 of the network COM. The nodal point V1 establishes the connection CON to a line-side device N1 in the network NEX, which is designed to interact with the terminal TER. The line-side device N1 can be determined by the nodal point V1, e.g., by means of an assignment chart between line-side devices and terminals. The terminal TER can now log on to the line-side device N1 in the already described manner, so that the line-side device N1 and the terminal TER can jointly offer telecommunication functions.

The line-side device N1 can furthermore establish a connection to a data processing installation S1 of the network SERV, and from there receive modules for service programs and application programs which the line-side device N1 can execute by itself, or in conjunction with the terminal TER. The extent to which the line-side device N1 performs service program functions, application program functions and telecommunication functions by itself, or strains the functions of the data processing installation S1, can be determined, e.g., in accordance with the efficiency of the line-side device N1 or the data processing installation S1, in accordance with the transmission capacity of the connection between the line-side device N1 and the data processing installation Si. However it is also possible to let the line-side device N1 perform the often required function parts, and to let the data processing installation S1 provide program modules for the less often required function parts. According to similar points of view, it can be determined what coverage the first function parts have in the terminal TER, and what coverage the second function parts have in the line-side device N1. Depending on the configuration of the means for performing the respective function parts, the terminal TER, e.g., can essentially limit itself to input and output functions, and the line-side device N1 can perform the remaining function parts of data processing and telecommunication. But program modules for performing the first function parts can also be stored in the terminal TER, or can be loaded by the line-side device N1 into the terminal TER, enabling the latter to perform these program modules by itself and in this way give the function parts an extended coverage.

To form the telecommunications network COM, both nodal points according to the invention with line-side devices according to the invention can be used, as well as known components, e.g., exchanges and transmission lines. Such exchanges can differentiate connection requests to the line-side devices of the network NEX, e.g., with the help of connection charts, or by means of special identifiers, e.g., telephone numbers or network addresses, from connection requests to communications partner devices which cannot be reached by the line-side devices according to the invention.

Devices known from intelligent networks can be used in the network SERV, e.g., service creation points, which then also offer application program functions in addition to providing service functions. But the network SERV can also be formed of smaller network units, e.g., local networks which can be reached by a group of line-side devices and are built similar to LANs (Local Area Networks).

The nodal points of the network NEX can be data processing installations operated in accordance with the invention, but which are otherwise conventional and are able to perform the function parts of the line-side devices, e.g., with the help of the already mentioned service profiles. The function parts of the line-side devices can also be performed by modules especially designed for this purpose, e.g., modules which contain a microprocessor, storage devices and input and output devices, and are connected to nodal points of the telecommunications network COM.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. A method of performing telecommunication functions, whereby at least a first line-side device (NE1) in a telecommunications network (TCN), and at least a first terminal (TER) for the telecommunications network (TCN) can be connected to each other,
wherein the first line-side device (NE1) checks whether it is connected to the first terminal (TER),
and wherein the functions are formed by the interaction of first function parts (F1) which are performed by the first terminal (TER), and second function parts (F21) which are performed by the first line-side device (NE1), as long as the first terminal (TER) is connected to the first line-side device, characterized in that if the first terminal (TER) is not connected to the first line-side device and the first function parts (F1) are therefore unable to interact with the second function parts (F21), the first line-side device (NE1) replaces or simulates the first function parts (F1) with third function parts (F31),
and that as a function of at least one determinable parameter, a second line-side device (NE2) instead of the first line-side device (NE1) performs such function parts (F22, F32), which are at least comparable to the second function parts (F21) of the first line-side device (NE1).

2. A method as claimed in claim 1, characterized in that in the telecommunications network (TCN) a connection to a communications partner device is established via the first line-side device (NE1) by the first terminal (TER), which is connected to the first line-side device (NE1).

3. A method as claimed in claim 1, characterized in that the first terminal (TER) is connected simultaneously to the first and the second line-side device (NE1, NE2).

4. A method as claimed in claim 1, characterized in that a second terminal is connected to the first line-side device (NE1), and that the second terminal performs fourth function parts which interact with the second function parts (F21).

5. A method as claimed in claim 1, characterized in that in addition to the telecommunication functions performed by the first line-side device (NE1) and the terminal, application program functions are also performed.

6. A line-side device (NE1) in a telecommunications network (TCN) for performing telecommunication functions, which contains means for connecting the telecommunications network (TCN) to at least one first terminal (TER),
which contains means whereby it is able to check whether it is connected to the first terminal (TER),
and which has means for performing second function parts (F21) which form the telecommunication functions by interacting with first function parts (F1) performed by the first terminal (TER), as long as the first terminal (TER) is connected to the line-side device (NE1), characterized in that the line-side device (NE1) has means for replacing or simulating the first function parts (F1) through third function parts (F31), if the first terminal (TER) is not connected to the line-side device (NE1), and the first function parts (F1) are therefore unable to interact with the second function parts (F21),
and that the line-side device (NE1) has means for evaluating a command which instructs the line-side device (NE1) to perform the second or third function parts (F21, F31).

7. A nodal point for a telecommunications network (TCN), characterized in that it contains at least one line-side device (NE1) as claimed in claim 6.

8. Data processing installation for a telecommunications network (TCN), characterized in that it contains at least one line-side device (NE1) as claimed in claim 6.

9. A terminal (TER) for a telecommunications network (TCN) containing at least one line-side device (NE1) as claimed in claim 6,
where the terminal (TER) has a device for a connection to the line-side device (NE1) and means for performing first function parts (F1), which are able to interact with the second function parts (F21) of the line-side device (NE1), characterized in that the terminal has means whereby, when the terminal (TER) is connected to the line-side device (NE1), it is able to transmit at least one service feature of the first function parts (F1) of line-side device (NE1).

10. A telecommunication system comprising a telecommunications network (COM) which contains nodal points and transmission paths, and to which at least one terminal (TER) can be connected,
and which contains a first network (SERV) that has at least one device (S1) for performing service functions, characterized in that the telecommunication system contains a second network (NEX) with line-side devices (N1) for performing telecommunication functions as claimed in claim 6, which is connected to the telecommunications network (COM) and to the first network (SERV) as well.
